(19) United States
(12) Patent Application Publication
(10) Pub. No.: US 2023/0264186 A1
(43) Pub. Date: Aug. 24, 2023

(54) DEVICES AND METHODS FOR TISSUE SAMPLE PROCESSING

(71) Applicant: 10x Genomics, Inc., Pleasanton, CA (US)

(72) Inventors: Bill Kengli LIN, Pleasanton, CA (US); Siyuan Xing, Newark, CA (US); Hanyoup Kim, Foster City, CA (US)

(21) Appl. No.: 18/151,344

(22) Filed: Jan. 6, 2023

Related U.S. Application Data
(60) Provisional application No. 63/297,474, filed on Jan. 7, 2022.

(51) Int. Cl. B01L 3/00

(52) U.S. Cl. CPC B01L 3/502; B01L 2200/16; B01L 2300/18; B01L 2300/161; B01L 2300/0645; B01L 2400/0406; B01L 2400/0457; B01L 2400/0677

(57) ABSTRACT

Disclosed herein are devices and methods for contacting a tissue sample with liquids to perform a variety of processes and analyses. In various embodiments, the device includes a hydrophilic flow path defined at least in part by a surface pattern (e.g., bounded by hydrophobic regions). The flow path includes a sample area sized to receive a biological sample. The flow path includes at least one valve configured to control flow in the flow path in response to an external stimulus.

### BACKGROUND

Many biomedical applications require tissue samples to be treated with reagents in liquid form. The process is typically labor and time intensive, requiring numerous careful pipetting steps. Therefore, there is a need for improved methods for application of liquids to tissue samples.

### BRIEF SUMMARY

Devices, methods, and systems for contacting tissue samples with liquids to perform a variety of processes and analyses are provided.

In a first aspect, a device includes a first surface that includes a first flow path including: (a) a sample area sized for placement of a tissue sample; (b) a liquid deposition area; (c) a liquid removal area; and (d) at least one valve disposed to control flow in the flow path in response to an external stimulus. The sample area is disposed between the liquid deposition area and the liquid removal area. The flow path is at least partially defined by a surface pattern that is more hydrophobic than the flow path.

In some embodiments, the at least one valve includes a first valve disposed in the flow path after the sample area and/or a second valve disposed in the flow path before the sample area . In certain embodiments, the external stimulus includes electric (e.g., electro-magnetic, electro-static, etc.), thermal, optical, mechanical, osmotic, or acoustic energy. In some embodiments, the flow path includes a hydrophilic or superhydrophilic surface. In particular embodiments, the surface pattern includes a hydrophobic or superhydrophobic surface. In certain embodiments, the device further includes a reservoir in fluid communication with the liquid deposition area.

In other embodiments, the device further includes a second surface facing the first surface, a spacer separating the first and second surfaces, an inlet in fluid communication with the liquid deposition area and an outlet in fluid communication with the liquid removal area. The second surface is more hydrophobic than the flow path or includes a second surface pattern that is more hydrophobic than, and complementary to, the flow path. In some embodiments, the second surface includes an array of bound reagents that aligns with the sample area. In certain embodiments, the sample area includes an array of bound reagents. In some embodiments, the device includes one or more electrodes (e.g., in one or more arrays) operatively coupled to the flow path. In some embodiments, the device includes a heating and/or cooling element (e.g., in one or more arrays) operatively coupled to the flow path. In some embodiments, the at least one valve includes a material (e.g., a wax) that changes phase (e.g., melts) in response to the external stimulus.

In another aspect, a method of contacting a tissue sample with a liquid is provided. The method includes (a) providing a device as described herein, (b) placing the tissue sample in the sample area, (c) applying the liquid to the liquid deposition area; and (d) allowing the liquid to flow in the flow path, thereby contacting the tissue sample with the liquid. In certain embodiments, the flow in step (d) is passive, e.g., by gravity, capillary action, surface tension, Laplace pressure, osmotic pressure, or a combination thereof.

In certain embodiments of the method, the device further includes a first valve, disposed in the flow path after the sample area, and step (d) further includes opening the first valve by application of an external stimulus, thereby allowing the liquid to flow from the sample area to the liquid removal area. In some embodiments of the method, the device further includes a second valve disposed in the flow path before the sample area, and step (d) further includes opening the second valve by application of the external stimulus, thereby allowing the liquid to flow to the sample area. In particular embodiments, the external stimulus includes electric (e.g., electro-magnetic, electro-static, etc.), thermal, optical, mechanical, osmotic, or acoustic energy. In some embodiments, the first surface is tilted to allow the liquid to flow in the flow path and/or to remove the liquid from the liquid removal area.

In another aspect, a system for contacting a tissue sample with a liquid is provided. The system includes any device having a flow path as described herein and a liquid dispenser, liquid handling robot, or tilt stage. In some embodiments, the system further includes a source of electric (e.g., electro-magnetic, electro-static, etc.), thermal, optical, mechanical, osmotic, or acoustic energy. In certain embodiments, the system further includes an aspirator.

In another aspect, a method of contacting a tissue sample with a liquid is provided. The method includes, providing a device including a sample area sized for placement of a tissue sample, a liquid deposition area, and a liquid removal area. The sample area is disposed between the liquid deposition area and the liquid removal area, and the flow path is at least partially defined by a surface pattern that is more hydrophobic than the flow path. The method further includes placing the tissue sample in the sample area; applying the liquid to the liquid deposition area; and allowing the liquid to flow in the flow path, thereby contacting the tissue sample with the liquid. The flow is passive, e.g., by gravity, capillary action, surface tension, Laplace pressure, osmotic pressure, or a combination thereof.

In another aspect, a system for contacting a tissue sample to a liquid is provided. The system includes a device a device including a sample area sized for placement of a tissue sample, a liquid deposition area, and a liquid removal area. The sample area is disposed between the liquid deposition area and the liquid removal area, and the flow path is at least partially defined by a surface pattern that is more hydrophobic than the flow path. The system further includes a liquid dispenser, liquid handling robot, or tilt stage.

It will be understood that the devices and methods described herein may, in addition to features specified, include any feature described herein that is not inconsistent with the structure of the underlying device, system, or method.

### Definitions

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ± 10% of a recited value.

The term “fluidically connected,” as used herein, refers to a direct connection between at least two device elements, e.g., a channel, reservoir, etc., that allows for fluid to move between such device elements without passing through an intervening element.

The term “in fluid communication with,” as used herein, refers to a connection between at least two device elements, e.g., a channel, reservoir, etc., that allows for fluid to move between such device elements with or without passing through one or more intervening device elements.

The term “tissue sample,” as used herein, refers to material from a subject, such as a biopsy, core biopsy, tissue section, needle aspirate, or fine needle aspirate or skin sample. The tissue sample may be derived from another sample.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that needs therapy or suspected of needing therapy. A subject can be a patient.

### BRIEF DESCRIPTION OF THE DRAWINGS

FIGS. 1A-1D show schematics of a portion of an embodiment of a device having a hydrophilic flow path (2), a surface pattern (6) (e.g., hydrophobic bounding regions), and actuatable valves (7,8), according to various embodiments.

FIGS. 2A-2C shows a schematic of a device on a tilt stage (11), according to various embodiments.

### DETAILED DESCRIPTION

Devices, methods, and systems for contacting a tissue sample with liquids, e.g., to perform a variety of processes and analyses are provided. The devices, methods, and systems are particularly advantageous for automating such processes and analyses.

### Devices

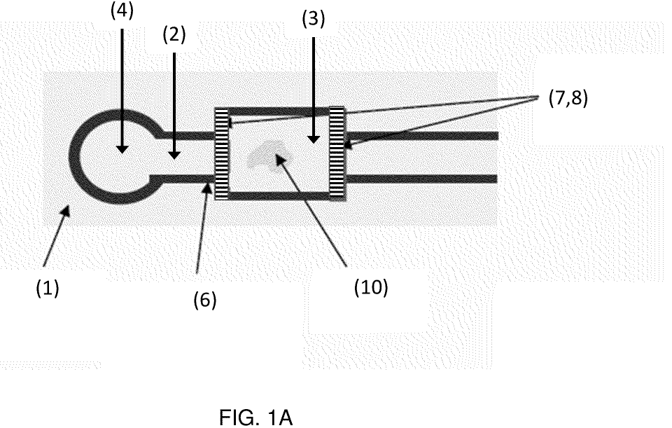

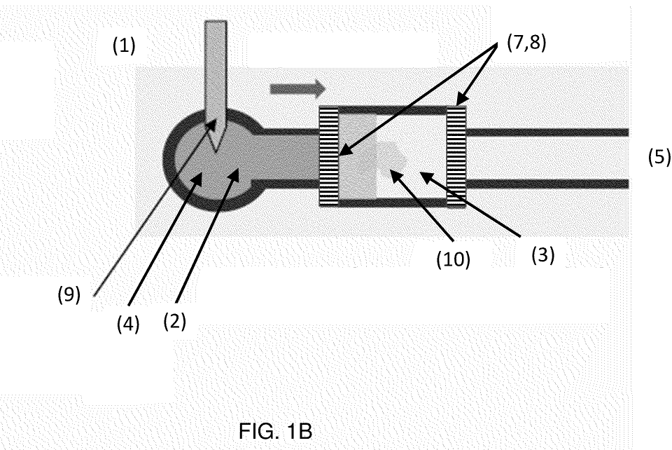

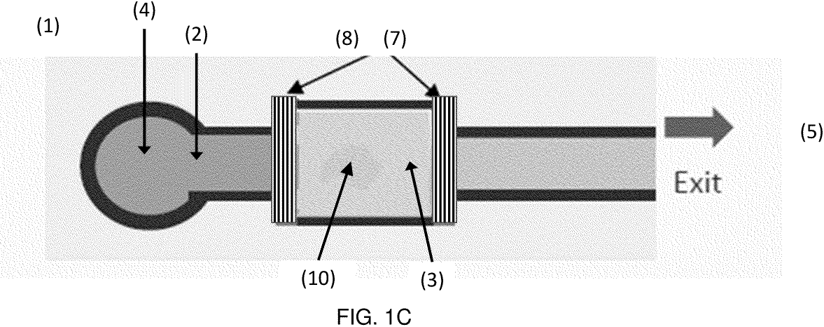

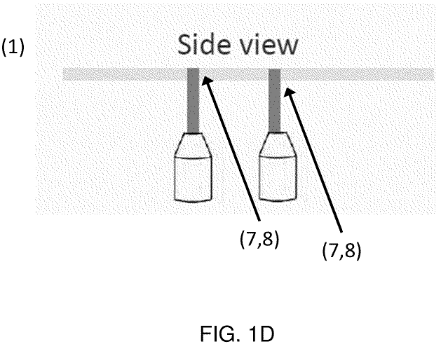

FIGS. 1A-1D illustrate devices having a hydrophilic flow path (2), a liquid deposition area (4), a sample area (3) with tissue sample (10), a liquid removal area, and two valves (7,8). FIG. 1A shows the flow path (2) before addition of liquid. FIG. 1B shows the dispensed liquid (from a dispenser (9), e.g., liquid dispenser, pipette, or liquid handling robot) wicking into the sample area (3), with the arrow showing the direction of wicking. FIG. 1C shows the liquid has filled the sample area (3), and the valves (7,8) are closed to hold liquid in contact with the tissue sample (10), e.g., before the liquid is removed (e.g., via the liquid removal area (5)). FIG. 1D shows a side view of the device when a laser actuates the valves (7,8).

In various embodiments, devices include a surface (1) with a defined flow path (2) and the surface (1) has varying surface characteristics configured to direct the flow of one or more liquids along the flow path (2). For example, the flow path (2) is hydrophilic, and the hydrophilic flow path (2) is bounded by a surface pattern (6) (e.g., hydrophobic regions). In various embodiments, the hydrophobic bounding regions (6) around the flow path (2) (and sample area (3)) cause aqueous liquids to flow substantially (e.g., entirely) along the hydrophilic flow path (2). The flow path (2) can include a sample area (3), sized for placement of a tissue sample (10), e.g., a biopsy or tissue section. The flow path can also include a liquid deposition area (4) and a liquid removal area. Devices supply liquids to a tissue sample (10) by allowing liquids provided to the liquid deposition area (4) to contact the tissue sample (10) in the sample area (3) as the liquids transit the flow path (2). The sample area (3) is disposed between the liquid deposition area (4) and the liquid removal area (5). Flow paths (2) are at least partially defined by a surface pattern (6) that is more hydrophobic than the flow path (2), e.g., a pattern of hydrophobic silane treated glass and hydrophilic untreated glass. Alternatively, the flow path (2) may be treated to be hydrophilic (e.g., by ozone), and the surrounding area is hydrophobic material (e.g., made from a material having a water contact angle greater than 90°), e.g., polypropylene or cyclic olefin copolymer. Within various embodiments, the device is configured to receive any tissue sample (10) that can placed in the sample area (3).

In some embodiments, devices can additionally include at least one valve (7,8) (see, e.g., FIGS. 1A-1D). In various embodiments, one or more valves (e.g., a first valve (7) at an inlet of the sample area and a second valve (8) at an outlet of the sample area (3))are disposed to control flow in the flow path (2). In various embodiments, the one or more valves (7,8) are actuatable between an open configuration and a closed configuration in response to an external stimulus. In various embodiments, the external stimulus is electric (e.g., electrowetting), thermal (e.g., resistive heating), optical (e.g., laser heating or photoelectrowetting), and/or acoustic energy (e.g., piezo vibration). The flow path (2) can include a hydrophilic or superhydrophilic surface. Where the flow path (2) is hydrophilic or superhydrophilic, the valves (7,8) may feature hydrophobic or superhydrophobic areas or other physical structures that allow wicking in response to the external stimuli, for example a hydrophobic dielectric material that becomes hydrophilic by the formation of an electric double layer in response to an electric field. In some embodiments, the pattern (6) includes a hydrophobic material, e.g., a low surface energy polymer such as polypropylene. A hydrophobic surface may include, or be in thermal communication with, a high extinction coefficient material, e.g., a pigment, e.g., carbon black. In some embodiments, the pattern (6) includes a superhydrophobic surface, e.g., zinc oxide polystyrene (ZnO/PS) nano-composite. A hydrophobic surface may include a material that changes surface energy in response to light energy, e.g., a semiconductor, e.g., amorphous or crystalline silicon. The pattern (6) may include both hydrophobic and superhydrophobic regions.

In some embodiments, the start and stop of the flow is controlled using the thermal-capillary principle. For example, a local gradient of temperature is formed underneath the flow path (e.g., before or after the intersections with the sample area) using an array of microheaters beneath the surface. The local gradient may be formed by individual heaters in the array being set to reach different temperatures when activated. Alternatively, selected heaters can be turned on while the others remain off. When the array is activated, the droplet will move from the warmer surface to the cooler surface because of the difference in surface tensions. Once the heaters are turned off, the droplets will stop moving. In some embodiments, an array of thermoelectric elements may provide heating and cooling, e.g., to enhance the temperature gradient.

In some embodiments, the start and stop of the flow is controlled by providing electrical energy, e.g., utilizing electrowetting or electrodewetting. The droplet movements may be controlled by embedded electrodes (e.g., metal pads) underneath the flow path. When electrical energy is provided, the electric potential causes the droplet to move. By sequentially activating the electrodes, one can control the movement of droplets.

In some embodiments, the start and stop of the flow controlled by providing optical energy, such as with a laser. For example, the valve regions can include a material that responds to light energy stimulation resulting in a change of wetting property. In one embodiment, the material is a wax that will become liquid upon excitation with a laser. The wax forms a natural barrier. When a laser is focused on the wax, the wax absorbs the energy and becomes a liquid, allowing the fluid to flow.

The device may further include a reservoir in fluid communication with the liquid deposition area. A reservoir may feature a raised lip or wall that fully or partially encompasses the liquid deposition area. Where the device includes such a reservoir, liquid can be driven through the flow path by hydrostatic pressure.

Devices can additionally include a second surface facing the first surface with a spacer separating them, thereby allowing the liquid operations to be conducted in a sealed or covered environment. The device can also include an inlet in fluid communication with the liquid deposition area and an outlet in fluid communication with the liquid removal area. The inlet and outlet may be configured to couple to a liquid handling system. In a device with two surfaces, the second surface may be more hydrophobic than the flow path or include a second pattern that is more hydrophobic than, and complementary to, the flow path. The second surface may act as a cover that does not contact the liquid. Alternatively, liquids traversing the flow path may be in contact with both surfaces. In some embodiments with two surfaces, non-passive actuation of liquids may be used, e.g., pneumatic actuation.

In some embodiments, the sample area or second surface, when present, may include an array of bound reagents. Examples of bound reagents include, but are not limited to, probes, primers, nucleotide triphosphates (NTPs, e.g., dNTPs), sequencing terminators, dyes, replicating enzymes (e.g., DNA or RNA polymerases, reverse transcriptases, ligases), labels, and the like.

### Flow Path

A flow path includes liquid deposition and removal areas and a sample area therebetween. A device may contain multiple (e.g., 1, 2, 3, 4, 5, 6, 7, 8, 9, 10, or more) flow paths, or a single flow path may contain multiple (e.g., 1, 2, 3, 4, 5, 6, 7, 8, 9, 10, or more) sample areas. Flow paths are at least partially defined by a pattern that is more hydrophobic than the flow path. The pattern confines hydrophilic liquids and allows them to flow without requiring an enclosed channel.

Advantageously, flow paths described herein allow liquid handling with substantially or entirely passive driving forces, e.g., gravity, capillary action, osmotic pressure, or Laplace pressure. The surface pattern can be formed by adding a hydrophobic or superhydrophobic coating to an otherwise hydrophilic substrate, leaving the flow path unmodified. Alternatively, when the native surface is already hydrophobic, as is the case with many polymer substrates, then the flow path may be made hydrophilic using methods of surface treatment and masking known in the art. More details of applicable, non-limiting, surface chemistries and techniques are detailed herein.

In some embodiments, the width and/or height of the flow path is, independently, from about 1 µm to about 1 cm. In some embodiments, width and/or height of the flow path is, independently, from about 1 µm to about 500 µm, from about 1 µm to about 250 µm, from about 10 µm to about 100 µm, from about 100 µm to about 500 µm, from about 100 µm to about 300 µm, from about 100 µm to about 200 µm, from about 120 µm to about 190 µm, or from about 150 µm to about 180 µm. In some embodiments, the width and/or height of the flow path is, independently, from about 1 µm to about 10 µm, e.g., about 1 µm, 2 µm, 3 µm, 4 µm, 5 µm, 6 µm, 7 µm, 8 µm, 9 µm, or 10 µm, e.g., from about 10 µm to about 100 µm, e.g., about 10 µm, 20 µm, 30 µm, 40 µm, 50 µm, 60 µm, 70 µm, 80 µm, 90 µm, or 100 µm, e.g., from about 100 µm to about 1 mm, e.g., about 100 µm, 200 µm, 300 µm, 400 µm, 500 µm, 600 µm, 700 µm, 800 µm, 900 µm, or 1 mm, e.g., from about 1 mm to about 1 cm, e.g., about 2 mm, 3 mm, 4 mm, 5 mm, 6 mm, 7 mm, 8 mm, 9 mm, or 1 cm.

In some embodiments, the length of the flow path is longer than the width and/or height of the flow path. In some embodiments, the length of the flow path is, e.g., from about 100 µm to about 10 cm, e.g., from about 100 µm to about 1 mm, e.g., about 100 µm, 200 µm, 300 µm, 400 µm, 500 µm, 600 µm, 700 µm, 800 µm, 900 µm, or 1 mm, e.g., from about 1 mm to about 1 cm, e.g., about 1 mm, 2 mm, 3 mm, 4 mm, 5 mm, 6 mm, 7 mm, 8 mm, 9 mm, or 1 cm, e.g., from about 1 cm to about 10 cm, e.g., 2 cm, 3 cm, 4 cm, 5 cm, 6 cm, 7 cm, 8 cm, 9 cm, or 10 cm.

In some embodiments, the thickness of the first and/or second surface is from about 1 µm to about 1 mm. In some embodiments, the thickness of the first and/or second surface is from about 1 µm to about 500 µm, from about 1 µm to about 250 µm, from about 10 µm to about 100 µm, from about 100 µm to about 500 µm, from about 100 µm to about 300 µm, from about 100 µm to about 200 µm, from about 120 µm to about 190 µm, or from about 150 µm to about 180 µm. In some embodiments, the thickness of the spacer between the first and second surfaces is from about 1 µm to about 10 µm, e.g., about 1 µm, 2 µm, 3 µm, 4 µm, 5 µm, 6 µm, 7 µm, 8 µm, 9 µm, or 10 µm, e.g., from about 10 µm to about 100 µm, e.g., about 10 µm, 20 µm, 30 µm, 40 µm, 50 µm, 60 µm, 70 µm, 80 µm, 90 µm, or 100 µm, e.g., from about 100 µm to about 1 mm, e.g., about 100 µm, 200 µm, 300 µm, 400 µm, 500 µm, 600 µm, 700 µm, 800 µm, 900 µm, or 1 mm.

The first surface and/or second surface may be any suitable shape, such as a square, rectangle, or circle, so long as to contain and/or visualize the sample. In some embodiments, the length and/or width of the first surface and/or second surface is, independently, from about 1 mm to about 10 cm, e.g., from about 1 mm to about 1 cm, e.g., about 2 mm, 3 mm, 4 mm, 5 mm, 6 mm, 7 mm, 8 mm, 9 mm, or 1 cm, e.g., from about 1 cm to about 10 cm, e.g., about 2 cm, 3 cm, 4 cm, 5 cm, 6 cm, 7 cm, 8 cm, 9 cm, or 10 cm. In some embodiments, the first surface and/or second surface is a coverslip, e.g., having dimensions of about 22 mm by 22 mm (square), about 24 mm by about 50 mm (rectangle), or a circle with diameter of about 12 mm or about 25 mm.

The liquid deposition area of the flow path may be configured to hold a droplet of liquid. The liquid deposition area may advantageously be configured to drive liquid through the flow path by Laplace pressure. For example, the liquid removal area may be sized and shaped to hold a droplet with a greater radius of curvature than that of a droplet in the liquid deposition area, thereby creating a pressure differential across the flow path which drives liquid through the flow path and over the sample.

The liquid deposition area may be substantially square, rectangular, circular, elliptical, ovoid, or any other shaped best suited to a particular application or method of operation. The liquid deposition area may be from about 1000 µm² to about 100 mm², e.g., about 1000-10,000 µm² (e.g., about 1000 µm², 2000 µm², 3000 µm², 4000 µm², 5000 µm², 60000 µm², 7000 µm², 8000 µm², 9000 µm², or 10,000 µm²), e.g., about 10,000-100,000 µm² (e.g., about 10,000 µm², 20,000 µm², 30,000 µm², 40,000 µm², 50,000 µm², 60,0000 µm², 70,000 µm², 80,000 µm², 90,000 µm², or 100,000 µm²), e.g., about 100,000 µm² to about 1 mm² (e.g., about 100,000 µm², 200,000 µm², 300,000 µm², 400,000 µm², 500,000 µm², 600,0000 µm², 700,000 µm², 800,000 µm², 900,000 µm², or 1 mm²), e.g., about 1-10 mm² (e.g., about 1 mm², 2 mm², 3 mm², 4 mm², 5 mm², 6 mm², 7 mm², 8 mm², 9 mm², or 10 mm²), or, e.g., about 10-100 mm² (e.g., about 10 mm², 20 mm², 30 mm², 40 mm², 50 mm², 60 mm², 70 mm², 80 mm², 90 mm², or 100 mm²).

The sample area may be sized and shaped to hold certain types of tissue sample, e.g., a biopsy or tissue section. Alternatively, or in addition, the sample area may be sized and shaped to fluidically interact with the liquid deposition area and liquid removal area in such a way as to draw sufficient liquid into itself from the liquid deposition area, and/or to encourage draining of the liquid to the liquid removal area, e.g., by Laplace pressure. The sample area may be substantially square, rectangular, circular, elliptical, ovoid, or any other shaped best suited to a particular application or method of operation. The sample area may be from about 1000 µm² to about 100 mm², e.g., about 1000-10,000 µm² (e.g., about 1000 µm², 2000 µm², 3000 µm², 4000 µm², 5000 µm², 60000 µm², 7000 µm², 8000 µm², 9000 µm², or 10,000 µm²), e.g., about 10,000-100,000 µm² (e.g., about 10,000 µm², 20,000 µm², 30,000 µm², 40,000 µm², 50,000 µm², 60,0000 µm², 70,000 µm², 80,000 µm², 90,000 µm², or 100,000 µm²), e.g., about 100,000 µm² to about 1 mm² (e.g., about 100,000 µm², 200,000 µm², 300,000 µm², 400,000 µm², 500,000 µm², 600,0000 µm², 700,000 µm², 800,000 µm², 900,000 µm², or 1 mm²), e.g., about 1-10 mm² (e.g., about 1 mm², 2 mm², 3 mm², 4 mm², 5 mm², 6 mm², 7 mm², 8 mm², 9 mm², or 10 mm²), or e.g., about 10-100 mm² (e.g., about 10 mm², 20 mm², 30 mm², 40 mm², 50 mm², 60 mm², 70 mm², 80 mm², 90 mm², or 100 mm²). The sample area may be greater than 100 mm² in area.

The sample area may contain reagents for sample processing, e.g., reagents for, e.g., lysis, amplification, labelling, etc. The sample area may also include or be disposed adjacent to components for heating and cooling, e.g., to incubate the sample at an appropriate temperature during treatment. Suitable heaters for the deposition head or inlet include, but are not limited to, thermoelectric heaters, e.g., thermistors, resistive foil, metal ceramic heaters, thermal tape, etc. Exemplary coolers include high thermal mass or high surface area heat sinks, heat exchangers, Peltier stages, etc.

In certain embodiments, the sample area is bracketed by one or more (e.g., two) valves, allowing liquids to be held in the sample area for a time appropriate to, e.g., label or incubate the sample with reagents.

The liquid removal area may be substantially square, rectangular, circular, elliptical, ovoid, or any other shaped best suited to a particular application or method of operation. The liquid deposition area may be from about 1000 µm² to about 100 mm², e.g., about 1000-10,000 µm² (e.g., about 1000 µm², 2000 µm², 3000 µm², 4000 µm², 5000 µm², 60000 µm², 7000 µm², 8000 µm², 9000 µm², or 10,000 µm²), e.g., about 10,000-100,000 µm² (e.g., about 10,000 µm², 20,000 µm², 30,000 µm², 40,000 µm², 50,000 µm², 60,0000 µm², 70,000 µm², 80,000 µm², 90,000 µm², or 100,000 µm²), e.g., about 100,000 µm² to about 1 mm² (e.g., about 100,000 µm², 200,000 µm², 300,000 µm², 400,000 µm², 500,000 µm², 600,0000 µm², 700,000 µm², 800,000 µm², 900,000 µm², or 1 mm²), e.g., about 1-10 mm² (e.g., about 1 mm², 2 mm², 3 mm², 4 mm², 5 mm², 6 mm², 7 mm², 8 mm², 9 mm², or 10 mm²), or e.g., about 10-100 mm² (e.g., about 10 mm², 20 mm², 30 mm², 40 mm², 50 mm², 60 mm², 70 mm², 80 mm², 90 mm², or 100 mm²). The liquid removal area may be configured to wick liquid off the device, e.g., by including high surface area, high surface energy components (e.g., an aligned array of microchannels) that draw liquid to the edge by capillary action. Alternatively, the liquid removal area may be configured for liquid removal by an aspirator.

### Valves

Devices may include one or more (e.g., 2, 3, 4, 5, 6, 7, 8, 9, 10, or more) valves (see, e.g., FIGS. 1A-1D). Valves are configured to restrict (e.g., prevent all flow) or permit the flow of liquid in response to an external stimulus, e.g., electric (e.g., electrowetting), thermal (e.g., resistive heating), optical (e.g., laser heating or photoelectrowetting), or acoustic energy (e.g., piezo vibration). For example, a valve may feature an electrowettable hydrophobic portion in the hydrophilic flow path which arrests the flow of liquid. When electric energy is supplied, the hydrophobic portion becomes hydrophilic, and the liquid is able to proceed along the flow path. Alternatively, the hydrophobic portion may be thermally conductive, and switched from hydrophobic to hydrophilic by the application of thermal energy, e.g., by resistive heating or laser light. Valves may include a material that changes state in response to external stimulation, e.g., a wax than melts in response to absorbing optical energy, e.g., from a laser.

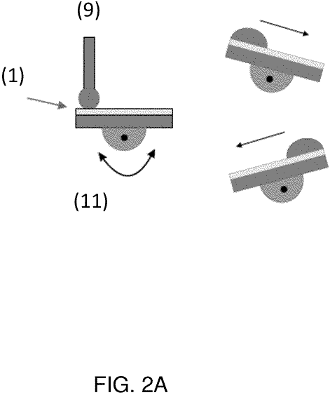

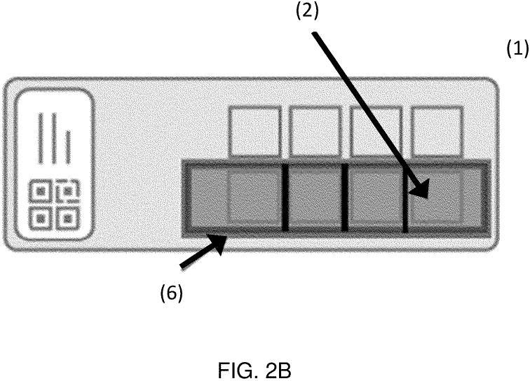

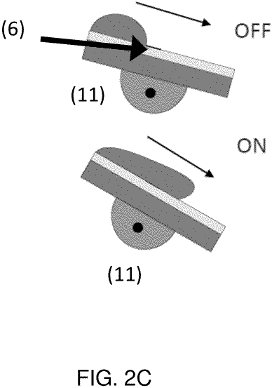

Valves may include, but are not limited to, any of the materials and surfaces discussed in the section on surface chemistry, below. Valves may include the native surface of the substrate, with or without surface patterning. Valves may include electroconductive and dielectric (e.g., metals, silica, or metal oxide glasses) materials for activation by electrowetting. Valves may include an array of electrodes to control the flow of liquid by electrowetting. Electrodes in an array may be independently (e.g., sequentially) activated to control the flow of liquid. A valve may be a feature of the surface pattern (e.g., a hydrophobic boundary (see, e.g., FIG. 2C).

Valves may include thermally conductive materials (e.g., metals, glass, certain ceramics and polymers, etc.). Thermal energy can be applied to the valves by, e.g., resistive or thermoelectric heaters, e.g., thermistors, resistive foil, metal ceramic heaters, thermal tape, etc. Thermal energy may also be applied by including an opaque material in, or in thermal contact with, the valve, thereby allow the valve to absorb thermal energy from a laser. To switch a thermal energy-activated valve to the “off” state, devices may include, e.g., thermoelectric cooling, or a high surface area, air cooled heat sink, in thermal contact with the valve. Valves may include an array of thermally conductive materials. Valves may include an array of heating or cooling elements, e.g., an array of microheaters or micro-Peltier modules. An array of conductive materials or heating elements may be configured to be independently activated (e.g., sequentially), or may be configured to reach a gradient of pre-set temperatures when the array is activated.

Valves may be controlled by light energy by incorporating optoelectronic materials in the valves, i.e., photoelectrowetting. Suitable materials for photoelectrowetting include, but are not limited to, dielectrics (e.g., silica or metal oxides glasses) and semiconductors (e.g., n-type or p-type silicon). Where optical or electric energy is used to activate a valve, removal of the stimulus may be sufficient to revert the valve to the previous state.

Valves may have a width (i.e., a dimension perpendicular to the direction of liquid flow) equal to or less than the width of the portion of the flow path that they bisect. Valves may have a length (i.e., a dimension parallel to the direction of liquid flow) from about 1 µm to about 1 mm, e.g., 1-10 µm (e.g., 1 µm, 2 µm, 3 µm, 4 µm, 5 µm, 6 µm, 7 µm, 8 µm, 9 µm, or 10 µm), e.g., 10-100 µm (e.g., 10 µm, 20 µm, 30 µm, 40 µm, 50 µm, 60 µm, 70 µm, 80 µm, 90 µm, or 100 µm), e.g., 100 µm to about 1 mm (e.g., 100 µm, 200 µm, 300 µm, 400 µm, 500 µm, 600 µm, 700 µm, 800 µm, 900 µm, or 1 mm). Valves may have a greater width than 1 mm.

### Surface Properties

The first surface, second surface, flow path, liquid deposition area, sample area, valves, and/or the liquid removal area of the device may have a surface modification, e.g., a surface with a coating, e.g., a hydrophobic coating, or a surface texture. A surface of the device may include a material, coating, or surface texture that determines the physical properties of the device. In particular, the flow of liquids, e.g., through or over a flow path, may be controlled by the device surface properties (e.g., wettability of a liquid-contacting surface). In some cases, a device portion (e.g., a flow path) may have a surface having a wettability suitable for facilitating liquid flow (e.g., in a flow path, e.g., between liquid deposition and sample area, e.g., in the liquid removal area).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn’s equation capillary rise method. The wettability of each surface may be suited to creating a hydrophobic boundary.

For example, portions of the device carrying aqueous phases (e.g., a channel or flow path) may have a surface material or coating that is hydrophilic or more hydrophilic than an adjacent region, e.g., include a material or coating having a water contact angle of less than or equal to about 90°, and/or an adjacent region may have a surface material or coating that is hydrophobic or more hydrophobic than the flow path, e.g., include a material or coating having a water contact angle of greater than 70° (e.g., greater than 90°, greater than 95°, greater than 100° (e.g., 95°-120° or 100°-10°)). In certain embodiments, the adjacent region may include a material or surface coating that reduces or prevents wetting by aqueous phases. The device can be designed to have a single type of material or coating throughout a first and/or second surface. Alternatively, the system may have separate regions having different materials or coatings. Surface textures may also be employed to control fluid flow.

The device surface properties may be those of a native surface (i.e., the surface properties of the bulk material used for the device fabrication) or of a surface treatment. Non-limiting examples of surface treatments include, e.g., surface coatings and surface textures. In one approach, the device surface properties are attributable to one or more surface coatings present in a device portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the device. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be deposited on a surface by contacting it with trimethylaluminum (TMA) and water.

In another approach, the surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°,75°,70°, 65°,60°, 55°,50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about 150°).

The difference in water contact angles between that of a hydrophilic or more hydrophilic material or coating and a hydrophobic or more hydrophobic material or coating may be 5° to 150°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, 35° to 60°, 55° to 80°, 65° to 80°, 75° to 90°, 75° to 100°, 80° to 115°, 85° to 120°, 115° to 130°, 125° to 150°, 135° to 150°, 145° to 150°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, 100°, 105°, 110°, 115°, 120°, 125°, 130°, 135°, 140°, 145°, or 150°.

Device surfaces may also be coated with various functional materials, e.g., metals or other electrically or magnetically conducting materials. For example, a surface may include a metal coating for electrical connectivity, detection, or resistive heating. Alternatively, such elements may be physically incorporated into a device or placed in physical contact with a device.

Device surface properties may also be modified after application. Such methods include exposure to UV, ozone, plasma (e.g., oxygen, argon, etc.), UV photografting and UV induced photo-catalytic oxidation. These and other methods can alter the properties of the surface (e.g., wettability such as hydrophilicity, fluorophilicity, or hydrophobicity) or add an additional layer (e.g., biomolecules) to the surface.

The above discussion centers on the water contact angle. It will be understood that liquids employed in the devices and methods may not be water, or even aqueous. Accordingly, the actual contact angle of a liquid on a surface of the device may differ from the water contact angle. Furthermore, the determination of a water contact angle of a material or coating can be made on that material or coating when not incorporated into a device.

### Additional Components

A device may contain one or more reservoirs. A single reservoir may also be connected to multiple flow paths in a device, e.g., when the same liquid is to be introduced at two or more different locations in the device. Waste reservoirs or overflow reservoirs may also be included to collect waste or overflow.

Alternatively, the device may be configured to mate with sources of the liquids, which may be external reservoirs such as vials, tubes, or pouches. Similarly, the device may be configured to mate with a separate component that houses the reservoirs. Reservoirs may be of any appropriate size, e.g., to hold 10 µL to 500 mL, e.g., 10 µL to 300 mL, 25 µL to 10 mL, 100 µL to 1 mL, 40 µL to 300 µL, 1 mL to 10 mL, or 10 mL to 50 mL. When multiple reservoirs are present, each reservoir may have the same or a different size.

In addition to the components discussed herein, devices can include additional components. For example, channels may include filters to prevent introduction of debris into the device. In some cases, the systems described herein may comprise one or more liquid flow units to direct the flow of one or more liquids, such as the aqueous liquid and/or the second liquid immiscible with the aqueous liquid. In some instances, the liquid flow unit may comprise a compressor to provide positive pressure at an upstream location to direct the liquid from the upstream location to flow to a downstream location. In some instances, the liquid flow unit may comprise a pump to provide negative pressure at a downstream location to direct the liquid from an upstream location to flow to the downstream location. In some instances, the liquid flow unit may comprise both a compressor and a pump, each at different locations.

In some instances, the liquid flow unit may comprise different devices at different locations. The liquid flow unit may comprise an actuator. Examples of pressure pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single device. The device may also include one or more vents to allow pressure equalization, and one or more filters to remove particulates or other undesirable components from a liquid. The device may also include one or more inlets and or outlets, e.g., to introduce and/or remove fluids, sample, or waste. Such additional components may be actuated or monitored by one or more controllers or computers operatively coupled to the device, e.g., by being integrated with, physically connected to (mechanically or electrically), or by wired or wireless connection.

### Medium

Liquid media may be used with a sample as described herein. The liquid media may be aqueous or nonaqueous (e.g., an oil). The liquid medium may contain reagents for preservation of the biological tissue sample. Examples of aqueous liquid media include, e.g., sterile water and phosphate buffered saline. Examples of oils include mineral oil and silicone oils. In various embodiments where reagents are included in the fluid, a non-aqueous liquid medium may confer the advantage of reducing diffusion of reagents beyond a desired region of the sample.

### Heating and Cooling

Devices and/or systems may include a heater and/or cooler, e.g., on or operatively connected to the device, e.g., in thermal contact with a fluid source, or in thermal contact with the sample area, or valves. Suitable heaters include, but are not limited to, thermoelectric heaters, e.g., thermistors, resistive foil, metal ceramic heaters, thermal tape, etc. Suitable heaters for heating the source of fluid include, but are not limited to, thermoelectric heaters, e.g., thermistors, resistive foil, metal ceramic heaters, thermal tape, a Peltier stage, a TEC controller, etc. Exemplary coolers include high thermal mass or high surface area heat sinks, heat exchangers, Peltier stages, flowing water, a chiller pump, etc. Devices may include a heating or cooling element, e.g., an array of heating and/or cooling elements, e.g., under o above the flow path, e.g., under the valves. Heating or cooling elements may be thermoelectric, e.g., microheaters or micro-Peltier modules. Heating and/or cooling elements may be high thermal conductivity materials (e.g., metals, ceramics, etc.) that transmit heat from a source of, e.g., thermal energy or optical energy. Devices may include multiple heating and/or cooling elements, e.g., in one or more arrays, e.g., an array of elements at each valve.

Heaters and coolers may be configured to supply fluid to, or heat, or cool a tissue sample in the sample area at appropriate temperatures to perform certain biochemical reactions, e.g., initialization, ligation, DNA melting, annealing, extension, denaturation, etc.

It will be understood that any of the heating sources and temperatures described herein may also be used together. For example, a Peltier stage may be used to heat a source of fluid, while a resistive foil or metal ceramic heater maintains the fluid temperature in the device.

### Reagents

The fluid sources described herein may contain one or more reagents that are delivered to a sample. A fluid source may include one or more (e.g., 2, 3, 4, 5, 6, 7, 8, 9, 10, or more) reagents, or each reagent may be contained in a distinct fluid source. In embodiments in which in situ-based methods are performed, the reagents include, but are not limited to, probes, primers, nucleotide triphosphates (NTPs, e.g., dNTPs), sequencing terminators, dyes, replicating enzymes (e.g., DNA or RNA polymerases, reverse transcriptases, ligases), labels, and the like.

Other reagents that may be provided by a fluid source include, without limitation, a tissue fixing agent, a tissue permeabilizer, such as a solvent (e.g., acetone and methanol) or a detergent (e.g., TRITON X-100, NP-40, TWEEN 20, saponin, digitonin, and Leucoperm).

### Methods of Device Manufacture

The devices of the present disclosure may be fabricated in any of a variety of conventional ways. These structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

Polymeric device components may be fabricated using any of a number of processes including soft lithography, embossing techniques, micromachining, e.g., laser machining, or, in some aspects, injection molding of the layer components that include the defined channels as well as other structures, e.g., reservoirs, integrated functional components, etc. In such cases, a laminating layer may be adhered to the molded structured part through readily available methods, including thermal lamination, solvent based lamination, sonic welding, or the like.

As will be appreciated, structures comprised of inorganic materials also may be fabricated using known techniques. For example, structures such as channels or reservoirs may be micro-machined into surfaces or etched into the surfaces using standard photolithographic techniques. In some aspects, the devices or components thereof may be fabricated using three-dimensional printing techniques to fabricate the channel or other structures of the devices and/or their discrete components.

### Methods for Surface Modifications

In various embodiments, methods are provided for producing a device that has a surface modification, e.g., a surface with a modified water contact angle. The methods may be employed to modify the surface of a device such that a liquid can “wet” the surface by altering the contact angle the liquid makes with the surface.

Devices to be modified with surface coating agents may be primed, e.g., pre-treated, before coating processes occur. In certain embodiments, the first contact angle is greater than the water contact angle of the primed surface. In other embodiments, the first contact angle is greater than the water contact angle of the device component surface. Thus, the method allows for the differential coating of surfaces within or on the device.

A surface may be primed by depositing a metal oxide onto it. Example metal oxides useful for priming surfaces include, but are not limited to, Al₂O₃, TiO₂, SiO₂, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be prepared on a surface by depositing trimethylaluminum (TMA) and water.

In some cases, the coating agent may create a surface that has a water contact angle greater than 90°, e.g., hydrophobic or fluorophilic, or may create a surface with a water contact angle of less than 90°, e.g., hydrophilic. For example, a fluorophilic surface may be created by flowing fluorosilane (e.g., H₃FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent.

### Methods of Operation

In various embodiments, methods are provided for contacting a tissue sample with a liquid. The method includes providing a device, then placing the tissue sample (e.g., a biopsy or tissue section) in the sample area before applying the liquid to the liquid deposition area (e.g., from a robotic liquid dispenser or pipette). The liquid is then allowed to flow (e.g., wicks in) in the flow path, thereby contacting the tissue sample. Methods particularly amenable to contacting a tissue sample using passive liquid flow. When the flow in the final step is passive, it may be by, e.g., gravity, capillary action, surface tension, Laplace pressure, osmotic pressure, or a combination thereof. For example, the device may be tilted to allow liquid to flow through the flow path in the direction of Earth’s gravitational field (see, e.g., FIGS. 2A-2C). The flow path of the device, being at least partially defined by a pattern that is more hydrophobic than the flow path, prevents liquid from flowing away from where it is needed to go (e.g., liquid stops at a hydrophobic boundary then passes the hydrophobic boundary with more tilting, as shown in FIG. 2C).

In certain methods, the device includes valves for controlling (e.g., start/stop, e.g., FIGS. 1A-1D) the flow of liquid through the flow path. Valves can allow additional steps, such as incubation, to be included in the workflow. Valves used in methods are configured to control the flow of liquid in response to an external stimulus. External stimuli can include, but are not limited to, electric (e.g., electrowetting), thermal (e.g., resistive heating), optical (e.g., laser heating or photoelectrowetting), or acoustic energy (e.g., piezo vibration or ultrasonics). Methods may include activating an array of electrodes or heating elements sequentially to control the flow of liquid across the valve. Methods may include inducing a phase change in a material disposed within the valve, e.g., with light or temperature.

In an exemplary method using valves, a first valve disposed in the flow path after the sample area, and the liquid flow step further includes opening the valve by application of an external stimulus to allow the liquid to flow from the sample area to the liquid removal area. Arresting the liquid flow in this way can allow sufficient liquid to build up in the sample area to appropriately cover the sample. Alternatively, or in addition, arresting the liquid with the first valve can be done to allow time for a reaction to take place, or to, e.g., incorporate a permeabilization or incubation step to the workflow, before opening the valve to allow reagents, etc., to be removed.

In another example, a second valve disposed in the flow path before the sample area, and the liquid flow step further includes opening the second valve by application of an external stimulus to allow the liquid to flow to the sample area (e.g., FIGS. 1A-1D). The second valve may be used to allow an appropriate amount of liquid to build up in the liquid deposition area before filling the sample area, or to isolate the filled sample area form the liquid deposition area.

In some methods, the surface is tilted to allow the liquid to flow in the flow path and/or to remove the liquid from the liquid removal area, e.g., using a tilt stage (e.g., FIGS. 2A-2C). The speed of liquid flow is controlled by the tilt angle, e.g., about 1°to 20° (e.g., 1°, 2°, 3°, 4°, 5°, 6°, 7°, 8°, 9°, 10°, 11°, 12°, 13°, 14°, 15°, 16°, 17°, 18°, 19°, or 20°). Liquid removal from the liquid removal area can be easily achieved by applying an extreme tilt angle (i.e., about 90°) (e.g., FIGS. 2A-2C).

### Preparation of Tissue Samples

A variety of steps can be performed to prepare a tissue sample for analysis. In some embodiments, a sample is collected or deposited in the device described here and prepared using a device described herein. In some embodiments, a prepared sample is placed on a sample area described herein. Except where indicated otherwise, the preparative steps described below can generally be combined in any manner to appropriately prepare a particular sample for analysis. In some aspects, any of the preparative or processing steps described can be performed on a sample using a device described herein, e.g., to deliver reagents via a fluid source. For example, the preparing or processing may include but is not limited to steps for fixing, embedding, staining, crosslinking, permeabilizing the sample, or any combinations thereof.

A tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 µm to about 20 µm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 µm. Thicker sections can also be used if desired or convenient, e.g., at least 70, 80, 90, or 100 µm or more. Typically, the thickness of a tissue section is about 1-100 µm, 1-50 µm, 1-30 µm, 1-25 µm, 1-20 µm, 1-15 µm, 1-10 µm, 2-8 µm, 3-7 µm, or 4-6 µm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the tissue sample (e.g., a tissue section as described above) can be prepared by deep freezing at a temperature suitable to maintain or preserve the integrity (e.g., the physical characteristics) of the tissue structure. Such a temperature can be, e.g., less than -20° C., or less than -25° C., -30° C., -40° C., -50° C., -60° C., -70° C., -80° C., -90° C., -100° C., -110° C., -120° C., -130° C., -140° C., -150° C., -160° C., -170° C., -180° C., -190° C., or -200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than -15° C., less than -20° C., or less than -25° C. A sample can be snap frozen in isopentane and liquid nitrogen. Frozen samples can be stored in a sealed container prior to embedding.

### Fixation and Postfixation

In some embodiments, the tissue sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a tissue sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre- permeabilization steps (described below) may not be performed. Alternatively, acetone fixation can be performed in conjunction with permeabilization steps.

In some embodiments, the methods provided herein comprises one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex comprising a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can comprise a nucleic acid molecule (e.g., reporter oligonucleotide) comprising a sequence corresponding to the labelling agent and therefore corresponds to (e.g., uniquely identifies) the analyte. In some embodiments, the labelling agent can comprise a reporter oligonucleotide comprising one or more barcode sequences.

A post-fixing step may be performed using any suitable fixation reagent disclosed herein, for example, 3% (w/v) paraformaldehyde in DEPC-PBS.

### Embedding

As an alternative to paraffin embedding described above, a tissue sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the tissue sample can be embedded in a matrix (e.g., a hydrogel matrix). Embedding the sample in this manner typically involves contacting the tissue sample with a hydrogel such that the tissue sample becomes surrounded by the hydrogel. For example, the sample can be embedded by contacting the sample with a suitable polymer material, and activating the polymer material to form a hydrogel. In some embodiments, the hydrogel is formed such that the hydrogel is internalized within the tissue sample.

In some embodiments, the tissue sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a tissue sample typically depends on the nature and preparation of the tissue sample (e.g., sectioned, non-sectioned, type of fixation). As one example, where the tissue sample is a tissue section, the hydrogel-matrix can include a monomer solution and an ammonium persulfate (APS) initiator/tetramethylethylenediamine (TEMED) accelerator solution. As another example, where the tissue sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 µm to about 2 mm.

Additional methods and aspects of hydrogel embedding of tissue samples are described for example in Chen et al., Science 347(6221):543-548, 2015, the entire contents of which are incorporated herein by reference.

### Staining and Immunohistochemistry (IHC)

To facilitate visualization, tissue samples can be stained using a wide variety of stains and staining techniques. In some embodiments, for example, a sample can be stained using any number of stains and/or immunohistochemical reagents. One or more staining steps may be performed to prepare or process a tissue sample for an assay described herein or may be performed during and/or after an assay. In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g., Dil, DiO, DiR, DiD). Other cell membrane stains may include FM and RH dyes or immunohistochemical reagents specific for cell membrane proteins. In some examples, the stain may include but is not limited to, acridine orange, acid fuchsin, Bismarck brown, carmine, Coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some embodiments, the sample may be stained with haematoxylin and eosin (H&E).

In some embodiments, tissue samples can be destained. Methods of destaining or discoloring a tissue sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### Isometric Expansion

In some embodiments, a tissue sample embedded in a matrix (e.g., a hydrogel) can be isometrically expanded. Isometric expansion methods that can be used include hydration, a preparative step in expansion microscopy, as described in Chen et al., Science 347(6221):543-548, 2015.

Isometric expansion can be performed by anchoring one or more components of a tissue sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the tissue sample can occur prior to immobilization of the tissue sample on a substrate, or after the tissue sample is immobilized to a substrate. In some embodiments, the isometrically expanded tissue sample can be removed from the substrate prior to contacting the substrate with probes disclosed herein.

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a tissue sample is isometrically expanded to a size at least 2x, 2.1x, 2.2x, 2.3x, 2.4x, 2.5x, 2.6x, 2.7x, 2.8x, 2.9x, 3x, 3.1x, 3.2x, 3.3x, 3.4x, 3.5x, 3.6x, 3.7x, 3.8x, 3.9x, 4x, 4.1x, 4.2x, 4.3x, 4.4x, 4.5x, 4.6x, 4.7x, 4.8x, or 4.9x its non-expanded size. In some embodiments, the sample is isometrically expanded to at least 2x and less than 20x of its non-expanded size.

### Crosslinking and De-crosslinking

In some embodiments, the tissue sample is reversibly cross-linked. In some aspects, the analytes, polynucleotides and/or product of an analyte or a probe bound thereto can be anchored to a polymer matrix. For example, the polymer matrix can be a hydrogel. In some embodiments, portions of the sample can be modified to contain functional groups that can be used as an anchoring site to attach to a polymer matrix. In some embodiments, a modified probe comprising oligo dT may be used to bind to mRNA molecules of interest, followed by reversible crosslinking of the mRNA molecules.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GelMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Pat. Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after the sample is in/on the device. For example, hydrogel formation can be performed on the sample on the sample area. In some embodiments, hydrogel formation occurs within a tissue sample. In some embodiments, a tissue sample (e.g., tissue section) is embedded in a hydrogel. In some embodiments, hydrogel subunits are infused into the tissue sample, and polymerization of the hydrogel is initiated by an external or internal stimulus.

In embodiments in which a hydrogel is formed within a tissue sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a tissue sample is permanent. For example, biological macromolecules can permanently adhere to the hydrogel allowing multiple rounds of interrogation. In some embodiments, hydrogel formation within a tissue sample is reversible.

In some embodiments, a method disclosed herein comprises de-crosslinking the reversibly cross-linked tissue sample. The de-crosslinking does not need to be complete. In some embodiments, only a portion of crosslinked molecules in the reversibly cross-linked tissue sample are de-crosslinked and allowed to migrate.

### Tissue Permeabilization and Treatment

In some embodiments, a tissue sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a tissue sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X-100™ or Tween-20™), and enzymes (e.g., trypsin, proteases). In some embodiments, the tissue sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the tissue sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the tissue sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the tissue sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a tissue sample to perform various functions prior to analysis of the sample. In some embodiments, DNase and RNase inactivating agents or inhibitors such as proteinase K, and/or chelating agents such as EDTA, can be added to the sample. For example, a method disclosed herein may comprise a step for increasing accessibility of a nucleic acid for binding, e.g., a denaturation step to open up DNA in a cell for hybridization by a probe. For example, proteinase K treatment may be used to free up DNA with proteins bound thereto.

### Analytes

The methods and compositions disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of a product. Alternatively, the specific binding partner may be coupled to a nucleic acid, which may be detected.

Analytes of particular interest may include nucleic acid molecules, such as DNA (e.g. genomic DNA, mitochondrial DNA, plastid DNA, viral DNA, etc.) and RNA (e.g. mRNA, microRNA, rRNA, snRNA, viral RNA, etc.), and synthetic and/or modified nucleic acid molecules, (e.g. including nucleic acid domains comprising or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which comprise a lipid or carbohydrate component. The analyte may be a single molecule or a complex that contains two or more molecular subunits, e.g., including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo- or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some embodiments, an analyte herein is endogenous to a tissue sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that comprises a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), doublestranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single-stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a tissue sample remains live during analysis, and analytes are extracted from (or released from) live cells of the sample. Live cell-derived analytes can be obtained only once from the sample, or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte comprises a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes comprise one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is comprised in the same analyte (e.g., nucleic acid) as the first single-stranded target sequence. Alternatively, the one or more second single-stranded target sequence is comprised in a different analyte (e.g., nucleic acid) from the first single-stranded target sequence.

### Labelling Agents

In some embodiments, provided herein are methods and compositions for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can comprise a reporter oligonucleotide that is indicative of the analyte or portion thereof interacting with the labelling agent. For example, the reporter oligonucleotide may comprise a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent comprises an analyte binding moiety and a labelling agent barcode domain comprising one or more barcode sequences, e.g., a barcode sequence that corresponds to the analyte binding moiety and/or the analyte. An analyte binding moiety barcode includes to a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method comprises one or more post-fixing (also referred to as post-fixation) steps after contacting the sample with one or more labelling agents.

In the methods and devices described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may comprise a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. 10,550,429; U.S. Pat. Pub. 20190177800; and U.S. Pat. Pub. 20190367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the tissue sample (e.g., a cell of the tissue sample) or an intracellular protein). In some embodiments, a plurality of analyte labelling agents comprising a plurality of analyte binding moieties bind a plurality of analytes present in a tissue sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may comprise nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that comprises a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer biding sequence (such as an R1, R2, or partial R1 or R2 sequence).

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the tissue sample can be subsequently associated with the one or more physical properties of the tissue sample. For example, the multiple different species of analytes can be associated with locations of the analytes in the tissue sample. Such information (e.g., proteomic information when the analyte binding moiety(ies) recognizes a polypeptide(s)) can be used in association with other spatial information (e.g., genetic information from the tissue sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

### Products of Endogenous Analyte and/or Labelling Agent

In some embodiments, provided herein are methods and compositions for analyzing one or more products of an endogenous analyte and/or a labelling agent in a tissue sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product thereof) is analyzed. In some aspects, the generation and/or processing of the analytes may be performed in/on the device and/or the analysis of the analytes may be performed in/on the device, such as by delivering reagents to a sample via applying liquid to the liquid deposition area, e.g., from a liquid source. For example, the generation, processing, and analysis may include but is not limited to reactions including hybridizations, ligations, binding, extension, amplifications, or other enzymatic reactions. In some embodiments, a labelling agent that directly or indirectly binds to an analyte in the tissue sample is analyzed. In some embodiments, a product (e.g., a hybridization product, a ligation product, an extension product (e.g., by a DNA or RNA polymerase), a replication product, a transcription/reverse transcription product, and/or an amplification product of a labelling agent that directly or indirectly binds to an analyte in the tissue sample is analyzed.

### Hybridization

In some embodiments, a product of an endogenous analyte and/or a labelling agent is a hybridization product comprising the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

Various probes and probe sets can be hybridized to an endogenous analyte and/or a labelling agent and each probe may comprise one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

### Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be comprised in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein comprises an enzyme that is commonly used to join polynucleotides together or to join the ends of a single polynucleotide. An RNA ligase, a DNA ligase, or another variety of ligase can be used to ligate two nucleotide sequences together. Ligases comprise ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases comprise bacterial ligases such as E. coli DNA ligase, Tth DNA ligase, Thermococcus sp. (strain 9° N) DNA ligase (9°N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps.” In some embodiments, said ends are not ligated directly to each other, but instead occurs either via the intermediacy of one or more intervening (so-called “gap” or “gap-filling” (oligo)nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9 or 10 or more nucleotides, of any integer (or range of integers) of nucleotides in between the indicated values. In some embodiments, the gap between said terminal regions may be filled by a gap oligonucleotide or by extending the 3′ end of a polynucleotide. In some cases, ligation involves ligating the ends of the probe to at least one gap (oligo)nucleotide, such that the gap (oligo)nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, comprising amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tₘ) of the DNA strands. This selectively reduces the concentration of annealed mismatched substrates (expected to have a slightly lower Tₘ around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification

In some embodiments, a product is a primer extension product of an analyte, a labelling agent, a probe or probe set bound to the analyte (e.g., a padlock probe bound to genomic DNA, mRNA, or cDNA), or a probe or probe set bound to the labelling agent (e.g., a padlock probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA comprises a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

### Target Sequences

A target sequence for a probe disclosed herein may be comprised in any analyte disclose herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in tissue samples, for example, within a cell or a particle tissue of the tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode comprises about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence comprises 4^{N} complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (4⁵=1024), whereas 8 nucleotide barcodes can be used to identify up to 65,536 molecular species, a number greater than the total number of distinct genes in the human genome. In some embodiments, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Assays

The methods described herein may be useful for analysis methods in which specific reagents are added to a sample. In some embodiments, reagents are added to the sample in the device which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the device after performing steps of the assay described herein. In some embodiments, the device is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. The methods described herein may be useful for array-based methods in which specific reagents are contacted with a sample. In some embodiments, the surface of the flow path, e.g., the surface of the liquid deposition area or sample area may have an array of bound reagents. In some embodiments, a device is used to deliver reagents to the sample which is deposited on the array.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a tissue sample. The tissue sample may be provided in the device, e.g., on a sample area. The sample may be permeabilized by adding a fluid, such as a solvent (e.g., acetone and methanol) or a detergent (e.g., TRITON X-100, NP-40, TWEEN 20, saponin, digitonin, and Leucoperm), to the sample. Permeabilization may allow or enhance access of the probes for the intracellular space of the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, the methods described herein includes in situ sequencing or sequence detection. One such process includes temporal multiplexing of barcoded probes. In some embodiments, a primary probe or set of primary probes hybridize to a target nucleic acid (e.g., mRNA) in the sample. Each probe may contain a barcode attached thereto. The barcodes may then be detected by contacting with one or more probes each labeled with a fluorescent label which emits a signal. Each round of barcoding may be initiated by flowing the desired probe from a new fluid source. The labels may be detected using different excitation wavelengths (e.g., 640 nm, 561 nm, or 488 nm) during different barcoding rounds. By compiling the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the tissue sample, or cells therefrom, may be sequence by using a probe that includes a unique gene identifier. The probe may be ligated, thereby allowing extension and amplification of the target sequence. In some embodiments, the amplification product can then be modified with a chemical moiety that polymerizes in the presence of a polymerization initiator. In some embodiments, an amplified product may be embedded within a polymerized matrix (e.g., a hydrogel), thereby creating spatially fixed three-dimensional target analytes of the tissue sample.

In some embodiments, the in situ sequencing includes sequencing by ligation. In this embodiment, fluorescently labeled probes with two known bases followed by degenerate or universal bases hybridize to a temple. A ligase immobilizes the complex and the tissue sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

In some embodiments, detection of one or more analytes (e.g., protein analytes) can be performed using one or more analyte capture agents. In some embodiment, the devices described herein may comprise one or more analyte capture agents, e.g., an array of oligonucleotides. In some aspects, the array may comprise a bead array. As used herein, an “analyte capture agent” refers to an agent that interacts with an analyte (e.g., an analyte in a tissue sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (ll)(b)(ix) of WO 2020/176788 and/or Section (ll)(b)(viii) U.S. Pat. Application Publication No. 2020/0277663.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the tissue sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (ll)(b)(vii) of WO 2020/176788 and/or U.S. Pat. Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligations products that serve as proxies for a template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended using reverse transcription. In some embodiments, the capture probe is extended using one or more DNA polymerases. The extended capture probes include the sequence of the capture probe and the sequence of the spatial barcode of the capture probe.

In some embodiments, extended capture probes are amplified (e.g., in bulk solution or on the array) to yield quantities that are sufficient for downstream analysis, e.g., via DNA sequencing. In some embodiments, extended capture probes (e.g., DNA molecules) act as templates for an amplification reaction (e.g., a polymerase chain reaction).

Additional variants of spatial analysis methods, including in some embodiments, an imaging step, are described in Section (ll)(a) of WO 2020/176788 and/or U.S. Pat. Application Publication No. 2020/0277663. Analysis of captured analytes (and/or intermediate agents or portions thereof), for example, including sample removal, extension of capture probes, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (ll)(g) of WO 2020/176788 and/or U.S. Pat. Application Publication No. 2020/0277663. Some quality control measures are described in Section (ll)(h) of WO 2020/176788 and/or U.S. Pat. Application Publication No. 2020/0277663.

Spatial information can provide information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

Spatial information can provide information of biological importance. For example, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

Typically, for spatial array-based methods, a sample area (e.g., as described herein) functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section (ll)(c) of WO 2020/176788 and/or U.S. Pat. Application Publication No. 2020/0277663. Exemplary features and geometric attributes of an array can be found in Sections (ll)(d)(i), (ll)(d)(iii), and (ll)(d)(iv) of WO 2020/176788 and/or U.S. Pat. Application Publication No. 2020/0277663.

Generally, analytes and/or intermediate agents (or portions thereof) can be captured when contacting a tissue sample with a substrate including capture probes (e.g., a substrate with capture probes embedded, spotted, printed, fabricated on the substrate, or a substrate with features (e.g., beads, wells) comprising capture probes). As used herein, “contact,” “contacted,” and/or “contacting,” a tissue sample with a substrate refers to any contact (e.g., direct or indirect) such that capture probes can interact (e.g., bind covalently or non-covalently (e.g., hybridize)) with analytes from the tissue sample. Capture can be achieved actively (e.g., using electrophoresis) or passively (e.g., using diffusion). Analyte capture is further described in Section (ll)(e) of WO 2020/176788 and/or U.S. Pat. Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a tissue sample (e.g., to a cell in a tissue sample). In some embodiments, a plurality of molecules (e.g., a plurality of nucleic acid molecules) having a plurality of barcodes (e.g., a plurality of spatial barcodes) are introduced to a tissue sample (e.g., to a plurality of cells in a tissue sample) for use in spatial analysis. In some embodiments, after attaching and/or introducing a molecule having a barcode to a tissue sample, the tissue sample can be physically separated (e.g., dissociated) into single cells or cell groups for analysis. Some such methods of spatial analysis are described in Section (III) of WO 2020/176788 and/or U.S. Pat. Application Publication No. 2020/0277663.

In some embodiments, the macromolecular components (e.g., analytes) of tissue samples (e.g., individual cells) can be identified or detected with unique identifiers (e.g., barcodes) such that upon characterization of those macromolecular components, such that any given component (e.g., bioanalyte) may be traced to the tissue sample (e.g., to an individual cell) from which it was obtained. The ability to attribute characteristics to individual tissue samples or groups of tissue samples (e.g., groups of cells) is provided by the assignment of unique identifiers specifically to an individual tissue sample or groups of tissue samples. Unique identifiers, for example, in the form of nucleic acid barcodes, can be assigned or associated with individual tissue samples (or, e.g., individual cells) or populations of tissue samples (e.g., cells), or genes (e.g., mRNA transcripts, in order to tag or label the tissue sample’s macromolecular components (and as a result, its characteristics) with the unique identifiers. These unique identifiers can then be used to attribute the tissue sample’s components and characteristics to an individual tissue sample or group of tissue samples.

In some aspects, the unique identifiers are provided in the form of oligonucleotides that comprise nucleic acid barcode sequences that may be attached to or otherwise associated with the nucleic acid contents of individual tissue sample, or to other components of the tissue sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) used in the methods described herein can also include other functional sequences useful in processing of nucleic acids from tissue samples (e.g., cells or cell components) contained in the droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

The methods described herein may include providing molecular labels, e.g., via a fluid source. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The devices and methods may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. US20190177800, US20190323088, US20190338353, and US20200002763, each of which is incorporated herein by reference in its entirety).

In an example, a fluid is provided that includes large numbers of the above described barcoded oligonucleotides releasably attached to a label. In some cases, a fluid will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more.

Oligonucleotides may be releasable from the labels (e.g., optical label, e.g., fluorescent label) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature will result in cleavage of a linkage or other release of the oligonucleotides from the label. In still other cases, a chemical stimulus is used that cleaves a linkage of the oligonucleotides to the label, or otherwise results in release of the oligonucleotides from the label, e.g., beads.

### Kits and Systems

In various embodiments, devices may be combined with various external components, e.g., heaters, coolers, detectors, pumps, reservoirs, or controllers, one or more detectors (e.g., one or more lenses (e.g., tube lens), microscope objectives, lasers, spectrometers, etc.), liquid handlers, reagents (e.g., detectable labels, such as nucleic acids, oligonucleotides, ligands, enzymes, proteins, fluorochromes, metal ions, etc., e.g., analyte detection moieties, liquids, particles (e.g., beads), and/or sample) in the form of kits and systems.

An exemplary system includes a device, a liquid dispenser, liquid handling robot, and a tilt stage (i.e., for using gravity as a driving force for liquid flow or removal of droplets from the liquid removal area). Such systems are particularly advantageous for incorporating devices into an automated workflow.

The system may further include external sources of electric (e.g., a power source), thermal (e.g., one or more lasers, a heater, etc.), optical (e.g., a laser or light-emitting diode), or acoustic energy (e.g., an ultrasonic emitter or piezoelectric component). In certain embodiments, the system further includes an aspirator.

Systems or kits of the method may further include methods of detection to allow, e.g., in situ detection of biological reactions, molecular tags, labelled nuclei, gene expression, transcripton expression, protein expression, etc.

While preferred embodiments of the present disclosure have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

Other embodiments are in the claims.

What is claimed is:

1. A device comprising a first surface comprising a first flow path comprising:
a) a sample area sized for placement of a tissue sample;
b) a liquid deposition area;
c) a liquid removal area; and
d) at least one valve disposed to control flow in the flow path in response to an external stimulus;
wherein the sample area is disposed between the liquid deposition area and the liquid removal area, wherein the flow path is at least partially defined by a surface pattern that is more hydrophobic than the flow path.

2. The device of claim 1, wherein the at least one valve comprises a first valve disposed in the flow path after the sample area and/or a second valve disposed in the flow path before the sample area.

3. The device of claim 1, wherein the external stimulus comprises electric, thermal, optical, mechanical, osmotic, or acoustic energy.

4. The device of claim 1, wherein the flow path comprises a hydrophilic or superhydrophilic surface.

5. The device of claim 1, wherein the pattern comprises a hydrophobic or superhydrophobic surface.

6. The device of claim 1, further comprising a reservoir in fluid communication with the liquid deposition area.

7. The device of claim 1, further comprising:
a second surface facing the first surface;
a spacer separating the first and second surfaces;
an inlet in fluid communication with the liquid deposition area; and
an outlet in fluid communication with the liquid removal area;
wherein the second surface is more hydrophobic than the flow path or comprises a second pattern that is more hydrophobic than and complementary to the flow path.

8. The device of claim 7, wherein the second surface comprises an array of bound reagents that aligns with the sample area.

9. The device of claim 1, wherein the sample area comprises an array of bound reagents.

10. The device of claim 1, further comprising one or more electrodes operatively coupled to the flow path.

11. The device of claim 1, further comprising a heating and/or cooling element operatively coupled to the flow path.

12. The device of claim 1, wherein the at least one valve comprises a material that changes phase in response to the external stimulus.

13. A method of contacting a tissue sample with a liquid, comprising:
a) providing a device of claim 1;
b) placing the tissue sample in the sample area;
c) applying the liquid to the liquid deposition area; and
d) allowing the liquid to flow in the flow path, thereby contacting the tissue sample with the liquid.

14. The method of claim 13, wherein the flow in step (d) is passive.

15. The method of claim 13, wherein the flow in step (d) is by gravity, capillary action, surface tension, Laplace pressure, osmotic pressure, or a combination thereof.

16. The method of claim 13, wherein the device further comprises a first valve disposed in the flow path after the sample area, and wherein step (d) further comprises opening the first valve by application of an external stimulus to allow the liquid to flow from the sample area to the liquid removal area.

17. The method of claim 13, wherein the device further comprises a second valve disposed in the flow path before the sample area, and wherein step (d) further comprises opening the second valve by application of an external stimulus to allow the liquid to flow to the sample area.

18. The method of claim 16, wherein the external stimulus comprises electric, thermal, optical, mechanical, osmotic, or acoustic energy.

19. The method of claim 13, wherein the first surface is tilted to allow the liquid to flow in the flow path and/or to remove the liquid from the liquid removal area.

20. A system for contacting a tissue sample to a liquid, comprising:
a) a device of claim 1; and
b) a liquid dispenser, liquid handling robot, or tilt stage.

21. The system of claim 20, further comprising a source of electric, thermal, optical, mechanical, osmotic, or acoustic energy.

22. The system of claim 20, further comprising an aspirator.
